(19) United States
(12) Patent Application Publication
(10) Pub. No.: US 2009/0025724 A1
(43) Pub. Date: Jan. 29, 2009

(54) System for removal of water from a hose and the hygroscopic hose utilized

(76) Inventor: Roy Howard Herron, JR., Starr, SC (US)

Correspondence Address: Thomas A. O'Rourke;Bodner & O'Rourke, LLP, 425 Broadhollow Road, Melville, NY, 11747, US

(21) Appl. No.: 12/218,667

(22) Filed: Jul. 16, 2008

Related U.S. Application Data
(60) Provisional application No. 60/959,752, filed on Jul. 16, 2007.

(51) Int. Cl. A62B 7/00; F16L 11/00

(52) U.S. Cl. 128/204.18; 138/177

(57) ABSTRACT

A respirator system and hygroscopic hose used in the system is disclosed. The system includes a means for generating a flow of air, a hose connected to the generating means and a mask adapted to be secured to a patient. The mask connected to the hose such that air generated by the generating means passes through the hose to the mask. The hose is a hygroscopic hose made up of a thermoplastic polyurethane. The thermoplastic polyurethane permits water formed by the respiration of the patient to permeate through a sidewall of said hose from an inner surface of the hose to an outer surface of the hose. The sidewall of the hose does not permit air generated by the generating means to pass through the sidewall.

This application claims priority on U.S. Application Ser. No. 60/959,752 filed Jul. 16, 2007, the disclosures of which are incorporated herein by reference.

### FIELD OF THE INVENTION

The present invention relates generally to the field of fluid removal, and in particular water, from the interior of hoses and more specifically to a system for the removal of water from a hose or tube utilizing a porous hose made of hygroscopic material, which draws water droplets away from the hose's interior and through the pores to the outside environment where they are evaporated, and the hygroscopic hose which is utilized to remove the water.

### BACKGROUND OF THE INVENTION

Sleep apnea is a sleep disorder characterized by pauses in breathing during sleep. Obstructive sleep apnea, the most common form, afflicts approximately 1 in 5 American adults, at least mildly. Normal sleep and wakefulness in adults is viewed in 6 distinct stages (Stages 1-4, REM Sleep, and Wake). The deeper stages, Stages 3 and 4, are required for the physically restorative effects of sleep and in pre-adolescents are the focus of release for human growth hormone. Because the muscles of the body relax greatly during Stage 2 of the sleep cycle, victims of obstructive sleep apnea suffer from a blockage to the flow air by the relaxed oropharynx. In cases where airflow is reduced to a degree where blood oxygen levels fall, or the physical exertion to breathe is too great, the brain triggers an interruption in the sleep, which may or may nor result in complete awakening, but can raise the person out of deep sleep and back into another stage in the sleep cycle. This sleep interruption in stages 3 and 4 can interfere with normal growth patterns, healing and immune response, especially in children and young adults. Moreover, individuals suffering from central sleep apnea, where the brain's respiratory control centers are imbalanced during sleep, may suffer the terrible consequences of brain damage or even death from an extremely lengthy deprivation of oxygen to the blood.

As a result of the seriousness of this condition, there are several treatment options for a person suffering from sleep apnea. For instance, the most widely used current therapeutic intervention is positive airway pressure, whereby a breathing machine pumps a controlled stream of air through a mask worn over the nose, mouth or both. The most frequently utilized positive away airway pressure system utilized is continuous positive airway pressure (CPAP). CPAP utilizes a controlled air compressor to generate an airstream at constant pressure. The pressure is prescribed by the patient's physician, based on overnight test or titration. Most CPAP systems include a flow generator, the machine which generates the controlled airstream, a hose, which connects the flow generator to the mask and a facemask, or interface, which connects to the user's nasal or oral airways or both.

Additionally, in order to prevent drying out of the nasal or oral canal and the complications that may occur with that, many CPAP systems utilize a humidifier to add moisture to the airstream being pumped into the user. Because the temperature within a person's room tends to drop over the course of the night, a common problem associated with these CPAP systems, is that condensation builds up within the hose of the CPAP system. As the temperature of the hose lowers with the room temperature, a temperature gradient between the warm humidifier and the cooler hose is created and some of the water vapor released pools in the hose as water droplets. Sometimes, these water droplets can converge and be so large that they are actually visible moving around the hose as the user sleeps. This problem is commonly referred to as “rainout,” and it complicates the usefulness of CPAP systems because, as the user shifts over the course of the night eventually, the pool of water in the hose may rise through the hose and into the facemask, causing the user of the CPAP system to inhale the water through the nose or the mouth, rapidly jolting him or her out of deep sleep and causing the very sleep interruptions that the CPAP machine is employed to prevent.

Preventing the pooling of water inside the hose is important to preventing this situation. Several designs exist to prevent this. Some CPAP hoses are produced with a heating wire coiled into the body of the hose or coiled freely inside the hose. The heat from the wire maintains the hose wall above the wet bulb temperature of the moisture-laden air preventing the condensation. Another common method employed is wrapping the CPAP hose with an insulating blanket. This method also keeps the hose wall above the wet bulb temperature of the moisture laden air. Both of the solutions are seen as bulky and/or heavy and/or costly.

Therefore, there is a need in the art for a means for removal of the water buildup that occurs in CPAP hoses as a result of the humidifier that is lightweight, less bulky and not as costly.

### SUMMARY OF THE INVENTION

The present invention is directed to a system for water removal from a hose utilizing porous hygroscopic material to absorb the water through the pores in the sidewall of the hose to the outside of the hose where it will be evaporated. In the preferred embodiment, the system is utilized to remove water from the interior of the hose of a mechanical ventilator, such as a CPAP system, typically utilized in the treatment of obstructive sleep apnea. The CPAP system comprises a machine body, a hose therein connected, facemask, which is connected to the end of the hose. Its purpose is to pump pressurized air into the person's oral and/or nasal airways at a force strong enough to clear any obstructions in the airway and prevent apneas. The CPAP system also typically contains a humidifier for adding moisture to the air that is being pumped into the user's airways. However, as stated above, the water vapor from the humidifier often liquefies in the hose into droplets and pools in the hose's interior, where it may be accidentally inhaled by the user of the CPAP system.

Therefore, the present invention includes a machine body, which houses a flow generator, from which air is pumped to the hose. The machine body preferably has a control panel on a surface with settings for adjustment of various controls, such as the air pressure, temperature and humidifier levels. There also will be a power source, such as a power cord, rechargeable battery, or even a connector into a car cigarette lighter. On the machine body's surface is also an orifice, from which the machine's hose extends.

In the present invention, the hose is generally made of a hygroscopic material strong enough to wick moisture away from the interior of the hose before it pools and causes a problem. Examples of such materials are polyurethane thermoplastic urethanes (TPUs), such as Tecophilic TPU, which has the ability to wick up to 100% of its weight depending upon which grade of material is used. The hose has a an interior sidewall and an exterior sidewall. In between the exterior and interior sidewall of the hose is a helix that runs the entire length of the hose, which gives the hose its accordion-like appearance and its ability to compress and expand as well as its flexibility. In the preferred embodiment the exterior and interior sidewall, as well as the helix all are made of the same hygroscopic material. However, in alternate embodiments any one or group of these pieces of the hose can be made of different materials. In particular, the helix may be made of a different material to create the desired support for the hose's infrastructure. In alternate embodiments, the hose also does not have a helix and may be unable to compress or expand.

Throughout the interior and exterior sidewalls are a series of small pores which allow moisture absorbed into the interior sidewall of the hygroscopic hose to be drawn to the outer environment. At both ends of the hose are cuffs which connect to the machine body and the facemask respectively. These cuffs are generally flat and smooth on their surface and will have a locking mechanism which secures them once they are connected with both the machine body and the facemask. It is preferable that this locking mechanism have the ability to be used with a number of different types of machine bodies and facemasks to make them usable with many different mechanical ventilators.

Finally, the CPAP system described above also utilizes a facemask which is connected to the hose and which carries the air pumped through the hose into the oral and/or nasal canals. Thus, the facemask preferably has a tube which connects with the hose at a nozzle which locks into the hose and prevents the escape of any air. This tube also preferably branches into two vessels, one which delivers the air to nasal-passage and one which delivers it to the mouth. In the preferred embodiment, there is also a mechanism for securing the facemask to the user's face comfortably, such as a strap or belt.

Although the present invention's preferred applicability is to a system for water removal from the hoses utilized in mechanical ventilators, there are other areas where the technology herein described would be equally applicable. One example of an alternate embodiment is the use of a hygroscopic hose in a building vent or duct system. Another alternative is a system for water removal in a vacuum cleaner or a gutter system on the outside of a building. Essentially, the present invention is applicable any time it is desirable to remove moisture from a hose or tube's interior.

### OBJECT OF THE INVENTION

Accordingly, it is an object of the invention to prevent users of CPAP systems from inhaling water that pools in a system's hose.

It is also an objection of the invention to develop a system for removing water from the interior of a hose or tube.

It is also an object of the invention to provide a system for removing water from the interior a hose or tube that is lightweight.

It is a further object of the invention to provide a system for removing water from the interior of a hose or tube that is not bulky.

It is a still further object of the invention to provide a system for removing water from the interior of a hose or tube that utilizes hygroscopic materials to absorb the water.

It is a still further object of the invention to provide a provide a system for removing water from the interior of a hose or tube that utilizes a porous hose or tube.

It is a still further object of the invention to provide a hose or tube which prevents moisture from building up in its interior.

It is a still further object of the invention to provide a hose or tube which removes water from its interior surface.

It is a still further object of the invention to provide a hose or tube which is made of a hygroscopic material.

It is a still further object of the invention to provide a hose or tube which is porous.

It is another object of the invention to provide a hose or tube which removes water from its interior surface and yet is still lightweight.

It is a final object of the invention to provide a hose or tube which absorbs water into its sidewalls, where the water is drawn into pores and eventually evaporates on the hose or tube's outer surface.

### BRIEF DESCRIPTION OF THE DRAWINGS

FIG. 1 shows a perspective view of one representative embodiment of the hygroscopic hose of the present invention.

FIG. 2 shows a perspective view of an alternate embodiment of the hygroscopic hose of the present invention.

FIG. 3 shows a perspective view of the preferred embodiment of the hose of the present invention without showing the cuffs at the ends of the hose.

FIG. 4 shows a cutaway view of a portion of the preferred embodiment of the hose of the present invention.

FIG. 5 shows a cutaway view of the interior of the preferred embodiment of the hose of the present invention.

FIGS. 6A and 6B show a representative view of a mask and respirator device respectively for generating a flow of air.

FIG. 7 shows an enlarged portion of a sidewall of the hose of the present invention.

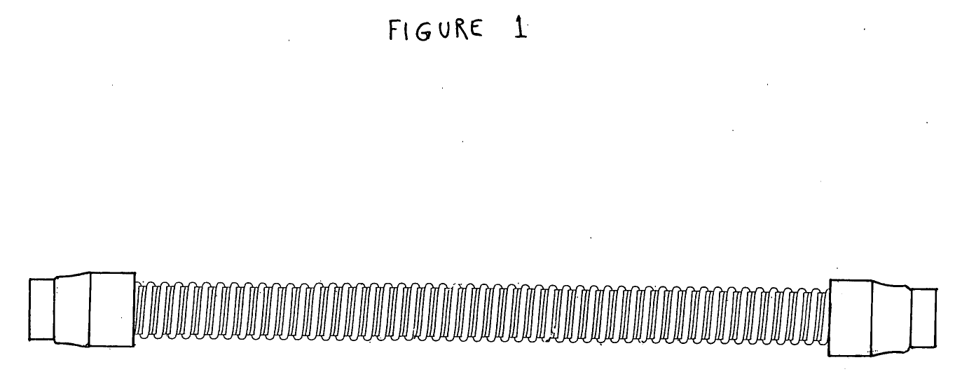

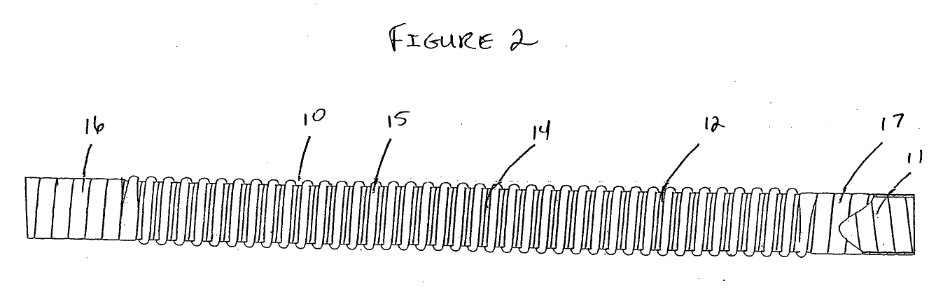

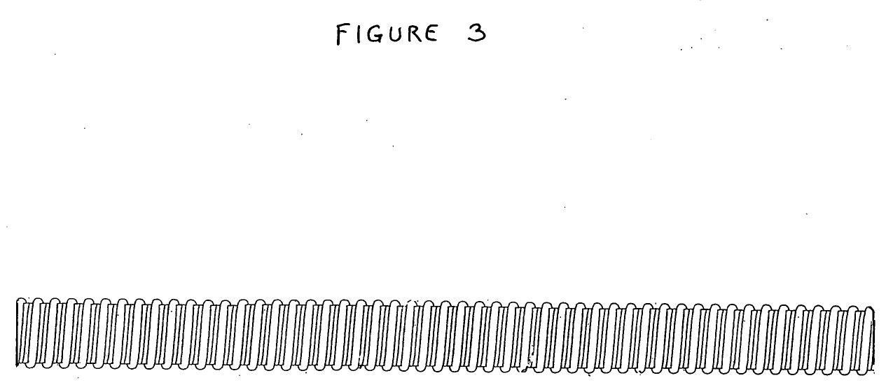

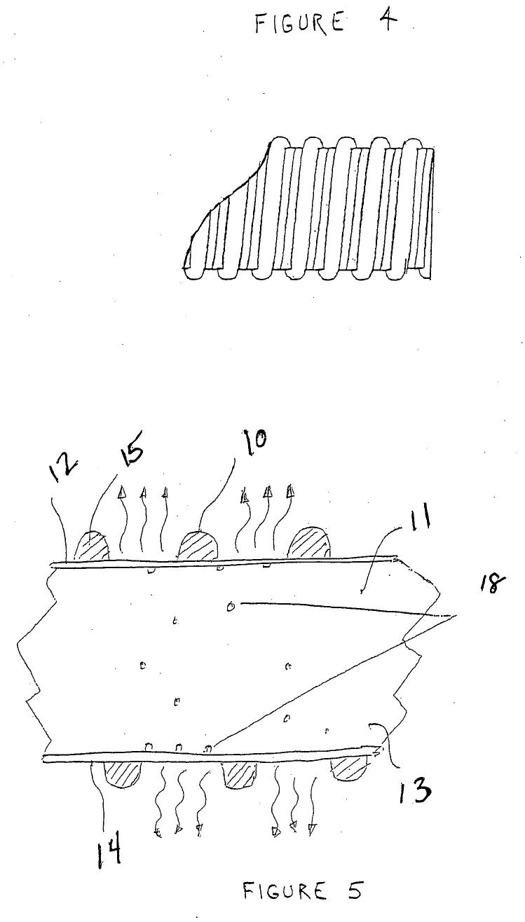

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is directed generally to a system for removing liquid buildup in respiratory tubes as well as the tube which performs the removal. This system employs a hose 10 comprising hygroscopic material which draws liquid out of the interior of the tube 11 to the exterior of the tube 12, where the liquid is evaporated. The hose 10 contains many tiny pores through which the water on the inside surface of the hose is absorbed in order to prevent liquid buildup within the hose 10. The moisture passes through the hose from the inside surface to the outside surface of the hose where it evaporates.

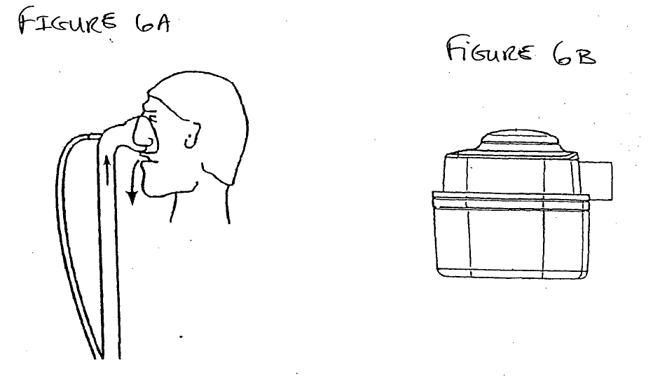

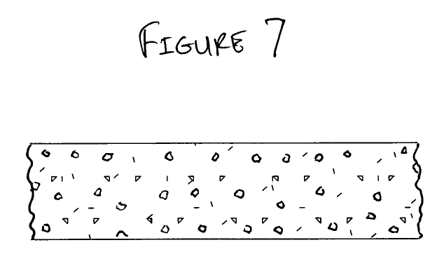

In the preferred embodiment, a respiratory machine (FIG. 6B), such as a continuous positive airway pressure (CPAP) system, is used to force air into a person's body through the mouth and, also preferably, through the nasal canal. This machine (FIG. 6B) preferably includes a body, a hose 10 extending from the machine to a facemask (FIG. 6A), meant to enclose the oral and nasal airways either individually or together. Most of the machine's activity is achieved within its body, which houses the “flow generator,” the mechanism that pumps air into the hose 10 for a user's respiration.

The machine body can have a series of control options which allow a user to adjust various settings on the flow generator, such as the air pressure, the air temperature and the humidifier. These controls preferably allow the user to increase or decrease the settings at which the machine operates. The body also contains a connection to a power source of some sort, whether it is a power cord, a connector for a car cigarette lighter, or a battery or fuel cell, which is contained within a compartment in the machine body. This battery is preferably rechargeable. In the preferred embodiment, there are portions of the machine body that are removable, in order to enhance the utility of the machine or make it easier to clean and/or operate. In an alternate embodiment the machine body has wheels to assist in easy transport the respirator. In another embodiment, the body contains a screen which displays the user's vital signs in order to ensure that the user's condition is stable throughout the process of the machine's operation. Where the body contains such a screen, a notification scheme may be utilized to make the user or others taking care of the user aware that the user is in distress. This may be achieved in any of a number of ways, but preferably, an audible notifier will be used, in order to awaken the user, if at all possible.

Extending from the machine body is a hose 10, through which air is pumped into the facemask that the user wears on his or her face. The hose 10 preferably has both an interior 13 and exterior sidewall 14 as well as a helical material that runs in between the interior and exterior sidewalls 14, giving the hose 10 its ability to compress and expand in response to the user's movements. The hose 10 itself is made of a hygroscopic material, which permits air to be channeled to the patient while at the same time absorbing water droplets that contact the interior sidewall 13 of the hose 10. At each end of the hose 10 may be a cuff that connects the hose 10 to the other components of the machine. One end connects the hose 10 into the flow generator and the other end of the hose 10 connects with the facemask.

The hose 10 is preferably made from hygroscopic material which is comprised of an interior sidewall 13 and an exterior sidewall. The hose is preferably made from one or more thermoplastic polyurethanes. The thermoplastic polyurethane is preferably extruded to form the hose of the present invention. The hose formed from polyurethane contains a plurality of pores usually randomly positioned throughout the hose creating voids and recesses that permit water to wick through the thermoplastic polyurethane from the interior to the exterior of the hose. The positive air pressure in the hose also helps facilitate movement of the water molecules from the inside surface of the hose to the exterior where the water molecules can evaporate. A preferred thermoplastic is a polyurethane based thermoplastic urethane (TPU), such as Tecophilic TPU, which has the ability to absorb water up to 100% of its weight, depending upon the grade of material used. However, other materials, such as polyether based thermoplastic polyurethane or polyester based TPU's may be utilized. Virtually any thermoplastic hygroscopic material may be used, although substances utilizing polyurethane are preferable, due to the tensile strength it possesses, which is necessary to counteract the porosity of the sidewall. The above-listed materials are also fairly lightweight yet flexible, which is an additional desirable quality for the present invention. The hygroscopic material of the interior sidewall 13 catalyzes an internal condensation whereby the sidewall absorbs water droplets contained within the hose's 10 interior to prevent a buildup of water. The pores (FIG. 7) in the interior sidewall 13 allow the water absorbed into the sidewall to be drawn out of the hose 10's interior and into the outside environment where it is evaporated.

The flexible hose of the present invention may be a single layer of a thermoplastic polyurethane. The hose may have a helical wire present to provide the hose with additional strength. The helical wire may be on an inside surface of the hose, an outside surface of the hose or it may be embedded in the thermoplastic polyurethane. The helical wire may be an electrical conducting wire, if desired. If the helical wire is on an inside surface or an outside surface, the wire may be coated and adhered to the surface by any suitable means such as an adhesive.

Although in the preferred embodiment the body of the hose consists essentially of one or more thermoplastic polyurethanes, the outer surface can have a covering over at least a portion of its surface provided the covering does not interfere unduly with evaporation of water passing through the hose.

Turning to the Figures, encircling the interior sidewall 13 from end to is a helical wire 15 which gives the hose 10 its flexibility and compressibility. This helix 15 is preferably made of the same hygroscopic material as the interior sidewall 13, in order to further promote water absorption. But, it may consist of different materials if so desired. For instance, any plastic or metal practicable to one in the art may be employed to make the helix 15 that wraps around the interior sidewall 13. Encasing the helix 15 is an exterior sidewall 14 that is generally made of the same hygroscopic material as the interior sidewall 13, although it may also be made of a different material. Like the interior sidewall 13, both the exterior sidewall 14 and the helix 15 may be porous, so that absorption of water droplets is enhanced. It is one key feature of the present invention that the water molecules pass through the thermoplastic polyurethane but air does not pass through the hose so that the patient receives the necessary oxygen for his treatment and any water or water vapor that contacts the inner surface of the hose is wicked through the pores in the hose to the outer surface where the evaporation effect of ambient air dries the outer surface of the hose. The transmission of water molecules through the hose sidewall is enhanced by the presence of the air passing through the hose to the patient's face mask. The pressure in the hose typically should not exceed about 30 inches of pressure to prevent damage to the patient's lungs. Nevertheless, the pressure in the hose helps push the molecules of water through the pores in the hose to the outside surface of the hose. It will be appreciated by those skilled in the art that the hose has a plurality of individual pores that are in the walls of the hose. These pores do not pass from one surface of the hose to the opposite surface. The pores are more in the form of bubbles or voids that are throughout the wall of the hose. These bubbles create openings in the sidewalls of the hose that extend a short distance into the hose not unlike the surface of a sponge.

The size of the hose does not matter, however the larger the diameter of the hose, the greater the interior surface area of the hose to facilitate contact with water molecules. The thickness of the sidewall can also vary.

On both ends of the helical hose 10 are cuffs 16 and 17 which connect the hose 10 with the other components of the respiratory machine. Both cuffs 16 and 17 are preferably made of the same hygroscopic material as the hose 10 itself, but may, if practical, be made of another material that is similarly lightweight, yet strong. In fact, in the preferred embodiment, the cuffs 16 and 17 are not molded, but are merely made from flattening the helix 15 of the hose 10 at both ends and smoothing them out to form non-flexible, non-helical cuffs. The cuffs may be injection molded onto the ends of the hose. In alternate embodiments, the cuffs 16 and 17 may be mechanically attached to the helical hose 10. The first cuff 16 is shaped so that it fits into an orifice in the machine body, connecting the hose 10 to the flow generator. The connector means may be any connection means which is well known in the art. There is preferably a locking mechanism that ensures that the hose 10 cannot be removed from the machine body accidentally during a user's sleep. In the preferred embodiment, however, the first cuff 16 may be removed from the machine body so that the user or a person caring for the user can clean the hose 10 or even to replace it with a new hose 10, if at all necessary. This may be achieved by a compartment that opens and closes, exposing the first cuff 16 to the user when open, so that the user may remove it easily. The first cuff 16 could also be easily unscrewed from the machine's body or could even be attached with a few easily removable screws which fit into small orifices on the machine body. Basically, any suitable means for attachment and removal of the cuff is possible in the present invention.

At the end opposite the first cuff 16 and the machine body, is a second cuff 17, which connects the hose 10 to the facemask used for carrying the airflow into the user's nasal and oral canals. This cuff locks into a nozzle at the end of the facemask and pumps air into the facemask. Like the first cuff 16, the second cuff 17 has a locking mechanism which secures it to the nozzle of the facemask. In the preferred embodiment, the nozzle fits within the interior of the second cuff 17 and locks in to attach itself to the cuff to prevent separation. This is achieved by a locking mechanism, such as a track for screwing in the nozzle or for snapping the nozzle into the second cuff 17. However, in alternate embodiments, the second cuff 17 fits within the nozzle and secures itself with a locking mechanism of the kind described above. A third embodiment achieves the locking of the second cuff 17 and the nozzle together by protrusions at the end of either the second cuff 17 or the nozzle that mate with orifices on the end of the other piece. In this embodiment, both pieces may be the same size in diameter, with it being unnecessary for one piece to fit inside the other piece. Alternate means of connecting the two pieces may be used as practical to someone skilled in the art. But, preferably, the hose 10 and the facemask are only temporarily attached, as removal of the hose 10 from the facemask would greatly assist in proper maintenance of the machine as well as assist in the machine's portability.

The facemask (FIG. 6A) which is attached to the hose 10 when the machine (FIG. 6B) is operational may be any of several types of facemasks known in the art. However, it must have a nozzle or other means for receiving the hose 10 described above, a means for delivering the air produced by the flow generator into both the oral and nasal airways at the desired pressure necessary to stimulate proper respiration, a means for attachment to a user's head, ensuring that the facemask is not accidentally removed during the user's sleep. Furthermore, there must be a means for assuring that the air pumped into the nasal and oral canals, does not escape before it is breathed in by the user. In this manner, the facemask, in the preferred embodiment, consists of a tube which at one end has a nozzle that connects with the helical hygroscopic hose 10. The tube branches at the other end of the tube into two separate tubes, one which delivers air to a user's mouth, and the other which pumps air into a user's nose. Many masks also contain an outer protective casing which covers the entire area around a user's nose and mouth and prevents air from escaping without being breathed. This casing usually has an interior surface, which touches the user's face and is concave, and typically cushioned with a foam of some sort in the areas where it meets the user's skin, so as to prevent irritation and discomfort. It also has an outer surface that is convex, so that the whole facemask protrudes outwardly from the surface of a user's face, comfortably fitting a user's nose and mouth within its confines. Typically, facemasks are made of plastic or other synthetic material that is lightweight but sturdy. In alternate embodiments, facemasks simply consist of the two end tubes, one which enters the user's nasal passage and the other which is placed inside a user's mouth. In nearly all embodiments of the facemask, however, there is a means for attaching the facemask to the user's face and holding it there, such as straps, padding, even suction material. These are all permissible means of attaching the facemask in the present invention.

Although, in the preferred embodiment, the present invention utilizes a CPAP system to deliver air into a user's nasal and oral airways, the present invention is not exclusively applicable to CPAP systems and, in alternate embodiments, other respiratory machines may utilize the system herein disclosed to remove liquid from their hoses 10. Examples of such applicable respiratory machines, include, but are not limited to, assist control (AC) machines, synchronized intermittent mandatory ventilators (SIMVs), pressure support ventilators (PSVs), controlled mechanical ventilators (CMVs), and positive end expiratory pressure (PEEP) ventilators.

In additional alternate embodiments, the present invention may be adapted to remove liquids other than water using a porous hose 10 made up of material that absorbs the liquid desired for removal. For instance, a buildup of mucus or saliva may exist in the respiratory hose 10. A hose 10 which would absorb these materials would be an alternate embodiment of the present invention.

Moreover, although the present invention is explained in its applicability to respiratory ventilators, such as CPAP machines and the like, in an alternate embodiment, the present invention could be adapted to remove water, or other liquids from ventilation systems in building, even gutters of the roofs of houses. Essentially, despite its utility in the arena of mechanical ventilators, the present invention is applicable to the desired removal of water from any hose 10 or tube.

I claim:

1. A respirator system comprising means for generating a flow of air, a hose connected to said means for generating a flow of air and a mask adapted to be secured to a patient, said mask connected to said hose such that air generated by said means for generating passes through said hose to said mask, said hose being comprised of a thermoplastic polyurethane, said thermoplastic polyurethane permitting water formed by the respiration of said patient to permeate through a sidewall of said hose from an inner surface of said hose to an outer surface of said hose, said sidewall of said hose not permitting air generated by said generating means to pass through said sidewall.

2. The system according to claim 1 wherein said thermoplastic polyurethane is a polyurethane based thermoplastic polyurethane.

3. The system according to claim 1 wherein said thermoplastic polyurethane is a polyether based thermoplastic polyurethane.

4. The system according to claim 1 wherein said thermoplastic polyurethane is a polyester based thermoplastic polyurethane.

5. The system according to claim 1 wherein said hose has at least one cuff at an end thereof for securing said hose to one of said generating means or said mask.

6. The system according to claim 1 wherein said hose has a helical member for providing strength to said hose.

7. The system according to claim 6 wherein said helical member is secured to said hose by means of an adhesive.

8. A hygroscopic hose for use with an gas transmission system, said hose comprising a thermoplastic polyurethane, said thermoplastic polyurethane permitting water present during gas transmission to permeate through a sidewall of said hose from an inner surface of said hose to an outer surface of said hose, said sidewall of said hose not permitting gas generated by an gas generating means connected thereto to pass through said sidewall.

9. The hose according to claim 8 wherein said thermoplastic polyurethane is a polyurethane based thermoplastic polyurethane.

10. The hose according to claim 8 wherein said thermoplastic polyurethane is a polyether based thermoplastic polyurethane.

11. The hose according to claim 8 wherein said thermoplastic polyurethane is a polyester based thermoplastic polyurethane.

12. The hose according to claim 8 wherein said hose has at least one cuff at an end thereof for securing said hose to one of said generating means or said mask.

13. The hose according to claim 8 wherein said hose has a helical member for providing strength to said hose.

14. The system according to claim 13 wherein said helical member is secured to said hose by means of an adhesive.

15. A hygroscopic hose comprising a thermoplastic polyurethane, said thermoplastic polyurethane, permitting water present to permeate through a sidewall of said hose from an inner surface of said hose to an outer surface of said hose, said hose having plurality of voids in said sidewalls for assisting said water to pass through said sidewall said voids being such size and configuration that air present in said hose does not pass through said sidewall with said water.
